(19) United States
(12) Patent Application Publication
(10) Pub. No.: US 2025/0148094 A1
(43) Pub. Date: May 8, 2025

(54) METHOD AND APPARATUS FOR CLOUD PLATFORM FOR SECURE ARTIFICIAL INTELLIGENCE MODEL TRAINING AND INFERENCE

(71) Applicant: Marvell Asia Pte Ltd, Singapore (SG)

(72) Inventor: Matthew Bashaw, Napa, CA (US)

(21) Appl. No.: 18/737,531

(22) Filed: Jun. 7, 2024

Related U.S. Application Data
(62) Division of application No. 18/737,380, filed on Jun. 7, 2024.
(60) Provisional application No. 63/547,661, filed on Nov. 7, 2023.
(60) Provisional application No. 63/626,497, filed on Jan. 29, 2024.

(51) Int. Cl. G06F 21/60

(52) U.S. Cl. CPC G06F 21/602

(57) ABSTRACT

A new approach is proposed that contemplates system and method to support a new network architecture for secure AI computing based on one or more secure, multi-core (SMC) data processing units (DPUs). Each of the SMC DPUs includes a gateway that ensures a secure interface and operating environment for the SMC DPU through encryption. Each of the SMC DPUs may further include a microprocessor core, one or more general purpose processing units (XPU cores) and/or customized processing units (CXPU cores), and a communications interface (COMM I/F) to external memories and other processing units. In some embodiments, a secure AI cloud cluster is constructed using multiple SMC DPUs along with one or more of switches, memories, separate XPUs, and high-speed interconnects (including optical interconnects) to ensure protection of client data for cloud-based AI services.

### RELATED APPLICATION

This application is a divisional application of U.S. patent application Ser. No. 18/737,380 filed Jun. 7, 2024, which is incorporated herein by reference in its entirety. The U.S. patent application Ser. No. 18/737,380 is a nonprovisional application and claims the benefit and priority to a provisional application No. 63/547,661 that was filed on Nov. 7, 2023, and a provisional application No. 63/626,497 that was filed on Feb. 7, 2024, respectively, both of which are incorporated herein by reference in their entireties.

### BACKGROUND

Cloud-based generative artificial intelligence (AI) services can be accessed via application programming interfaces (APIs), and units of work performed by such services can typically be billed based on number of one or more of: tokens (text, e.g., words or parts of words), pixels (images), frames (video), and time steps (audio). For example, generative AI services provided by OpenAI can be accessed by APIs according to an established price structure.

While entities, e.g., companies, organizations, governments, and other entities, seek opportunities in utilizing or leveraging these generative AI services, they are mindful of risks associated with any input to and/or output from public AI platforms offering the generative AI services such as ChatGPT, Gemini, Bing, CoPilot, etc. These public AI platforms may utilize confidential and proprietary information of the entities and cause such confidential and proprietary information entering the public domain. In some cases, the risks of public disclosure of the confidential and proprietary information may pose barriers to or even prevent the entities from using the generative AI services for business purposes.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a diagram of a network architecture of a SMC DPU 100 for secure AI computing according to one aspect of the present embodiments.

FIG. 2 depicts an example of a secure AI cloud cluster comprising a plurality of SMC DPUs connected with each other as well as with external memories and data processing units via high-speed interconnects according to one aspect of the present embodiments.

FIG. 3 depicts an example of a switch used in a cloud network and coupled via a plurality of high-speed active interconnects according to one aspect of the present embodiments.

FIG. 4 depicts an example of an interconnected switch-enabled AI cloud network comprising a plurality of switches, SMC DPUs, and memories according to one aspect of the present embodiments.

FIG. 5 depicts an example of a network architecture for providing secure services to clients according to one aspect of the present embodiments.

FIG. 6 depicts another example of a network architecture for providing secure AI services to clients according to one aspect of the present embodiments.

FIG. 7 depicts yet another example of a network architecture for providing secure AI services to clients according to one aspect of the present embodiments.

FIG. 8 depicts a flowchart of an example of a process to support secure AI computing according to one aspect of the present embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

A new approach is proposed that contemplates system and method to support a new network architecture for secure AI computing based on one or more secure, multi-core (SMC) data processing units/cores (DPUs). Each of the SMC DPUs includes a gateway that ensures a secure interface and operating environment for the SMC DPU through encryption. Each of the SMC DPUs may further include a microprocessor core, one or more general purpose processing units (XPU cores) and/or customized processing units (CXPU cores), and a communications interface (COMM I/F) to external memories and other processing units. In some embodiments, a secure AI cloud cluster is constructed using multiple SMC DPUs along with one or more of switches, memories, separate XPUs, and high-speed interconnects (including optical interconnects) to ensure protection of client data for cloud-based AI services.

The proposed new network architecture for secure AI computing addresses client data secrecy and security through encryption and it can utilize third party processing algorithms that tailor/customize one or more processing units for specific applications. The proposed network architecture can accommodate and maintain veil of secrecy for its input and output data as AI tools and services are used by entities desiring to prevent public disclosure of their confidential and proprietary client information. The proposed new network architecture can also be utilized by organizations that own and operate their own AI processing hardware (e.g., through a mix of off-the-shelf and customer semiconductor devices) to support secure analysis, engineering, and operational activities.

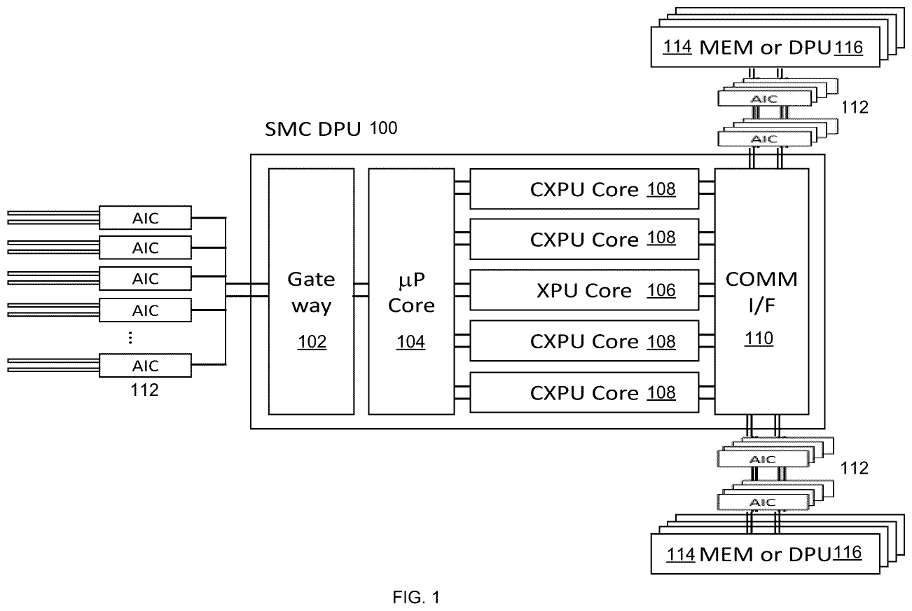

FIG. 1 depicts an example of a diagram of a network architecture of a SMC DPU 100 for secure AI computing. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the SMC DPU 100 includes one or more of a gateway 102, a microprocessor core 104, a general purpose XPU core 106, one or more customized XPU (CXPU) cores 108s, and a communications interface (COMM I/F) 110. It is appreciated that one or more components of the SMC DPU 100 may run on one or more computing units or devices (not shown) each with software instructions stored in a storage unit such as a non-volatile memory of the computing unit for practicing one or more processes. When the software instructions are executed, at least a subset of the software instructions is loaded into memory by one of the computing units, which becomes a special purposed one for practicing the processes. The processes may also be at least partially embodied in the computing units into which computer program code is loaded and/or executed, such that, the computing units become special purpose computing units for practicing the processes.

It is appreciated that the example depicted in FIG. 1 is for illustration only, wherein the SMC DPU 100 may have more than one general purpose XPU core 106 or equivalent, and it may have more or less than 4 CXPU cores 108s as shown. In some embodiments, the SMC DPU 100 may be a monolithic single chip device. In some embodiments, the SMC DPU 100 may comprise a number of connected chiplets. In some embodiments, the SMC DPU 100 may not have a COMM I/F.

In the example of FIG. 1, the gateway 102 of the SMC DPU 100 is configured to receive incoming/input data/request for service from a client through one or more high-speed interconnects 112s, which can be but are not limited to active interconnects (AICs) or regular interconnect wires such as copper connections, wherein each AIC utilizes one or more electronic devices to enhance/improve signal quality at the transmitting and/or receiving end of the interconnects as shown in FIG. 1. Here, the client can be any hardware or software component that needs a service, wherein such client can be but is not limited to an application, a function, or a user of the service. In some embodiments, electronic cables can have electronics at one end or the other or both; optics, on the hand, need electronics at both ends wherein the electronics may be used to improve the signal at one end or the other or both. In some embodiments, each AIC is implemented via co-packaged optics (CPO) or other high speed electronics. Here, CPO is a technology that integrates optical components into a single package, such as a switch ASIC package, to address challenges in bandwidth density, communication latency, copper reach, and power efficiency in data transmission networks. It is best suited for large Ethernet network switches to improve the performance and power efficiency as discussed below. In some embodiments, the SMC DPU 100 is configured to select one of the high-speed interconnects 112s to send traffic to a particular destination. In some embodiments, the communications interface (COMM I/F) 110 of the SMC DPU 100 is configured to interface to and interact with one or more external memories (MEM) 114s and other data processing units 116s via one or more high-speed interconnects 112s. Here, each of the data processing units 116s can be a separate XPU and/or another SMC DPU.

In some embodiments, the incoming data/request for service received by the gateway 102 of the SMC DPU 100 is encoded/encrypted with, for a nonlimiting example, dual-key encryption, by a client. In some embodiments, other encoding/encryption method including but not limited to an encryption managed by key exchange, a hard-coded encryption, etc. can also be used. In some embodiments, the incoming data includes data to be processed by the general purpose XPU core 106 and the CXPU cores 108s as well as a set of computation instructions to be executed by the general purpose XPU core 106 and the CXPU cores 108s to process such data. For a non-limiting example, the incoming data may include computational instructions for networking/selecting processors, etc. within a gateway boundary discussed below. Upon receiving the encrypted incoming data, the gateway 102 of the SMC DPU 100 is configured to decode/decrypt the incoming data and to parse out the set of computation instructions from the data to be processed. The gateway 102 then provides the computation instructions and the data to the general purpose XPU core 106 and the CXPU cores 108s for processing. Once the data is processed, the gateway 102 is configured to encrypt the processing result/outcome of the data before transmitting the encrypted processing result back to the client via the one or more high-speed interconnects 112s. As such, the gateway 102 of the SMC DPU 100 preserves secrecy of the data and instructions received from the client as well as secrecy of processed result returned to the client. The gateway 102 further preserves secrecy of the CXPU cores 108 and their underlying algorithms.

In the example of FIG. 1, the microprocessor core 104 is configured to control the operation of the SMC DPU 100 and manage data transfer between the gateway 102 and the general purpose XPU core 106 and the CXPU cores 108. For a non-limiting example, the microprocessor core 104 can be but is not limited to an ARM core. In some embodiments, the microprocessor core 104 is configured to direct the set of computation instructions and the data to be processed to one or more of the general purpose XPU core 106 and/or the CXPU cores 108 available and suitable for processing the data. The microprocessor core 104 is also configured to provide the processing outcome of the data from the one or more of the general purpose XPU core 106 and/or the CXPU cores 108 back to the gateway 102 for encryption before transmitting the processing outcome to the client.

In the example of FIG. 1, the general purpose XPU core 106 and the CXPU cores 108 are configured to process the decrypted data by executing the set of computation instructions to generate a processing result. Here, each of the general purpose XPU core 106 and the CXPU cores 108 is a processing unit which type/architecture is suited for organizing and/or processing certain type of data, which can be but is not limited to scalar (e.g., a CPU), vector (e.g., GPU), tensor (e.g., TPU), language processing (e.g., LPU), or an architecture suited for any other neural network (or any other model) for network processing. In some embodiments, the general purpose XPU core 106 and the CXPU cores 108 may include open source cores, licensed cores, and cores selected from a proprietary catalog provided by customers or a customer community. In some embodiments, the general purpose XPU Core 106 is configurable/programmable using an instruction set stored in memory 114 at runtime.

In some embodiments, the microprocessor core 104 and/or the general purpose XPU core 106 allow configuration to be updated as requirements evolve. In some embodiments, configuration and operating instructions (i.e., code) of the microprocessor core 104 and/or the general purpose XPU core 106 can be maintained in the memory 114 and may also be encrypted. Periodically, the SMC DPU 100 can be upgraded when a general purpose XPU core 106 and/or a CXPU core 108 cannot accommodate all new requirements.

In some embodiments, the one or more CXPU Cores 108 comprise circuits that can be hard-coded with a specific processing algorithm tailored for one or more specific applications to process the decrypted data. In some embodiments, the one or more CXPU cores 108 may be designed by third parties with encrypted intellectual property (IP) and accessed via one or more APIs, wherein the APIs may be used to configure the one or more CXPU Cores 108 for the specific applications and/or outcomes. In some embodiments, the one or more CXPU cores 108 may comprise proprietary, open source, or mixed architectures, circuits, firmware, and algorithms. In a rapidly evolving environment with a variety of applications, a catalog of different types of CXPU cores 108 from different designers (e.g., companies, consortia, etc.) can be made available to fabricate customized silicon for a specific application.

Once the data has been processed, the general purpose XPU core 106 and the CXPU cores 108 are configured to access the communications interface (COMM I/F) 110 to store the data in the external memories 114 and/or to transfer the data to other data processing units 116 via the one or more high-speed interconnects 112s. In some embodiments, the communications interface (COMM I/F) 110 is configured to connect to and communicate with other units using IP packets via Compute Express Link (CXL) protocol or another protocol that defines interactions between I/O devices with extremely low latency using a request and response approach. In some embodiments, the processing outcome/result is received and encrypted with, e.g., dual-key encryption, by the gateway 102 before being returned to the client, which manages data and organizes the processed data for future applications. Importantly, the connections/interactions with the external memories 114 and/or the other data processing units 116 are inside the secured environment protected by the gateway 102.

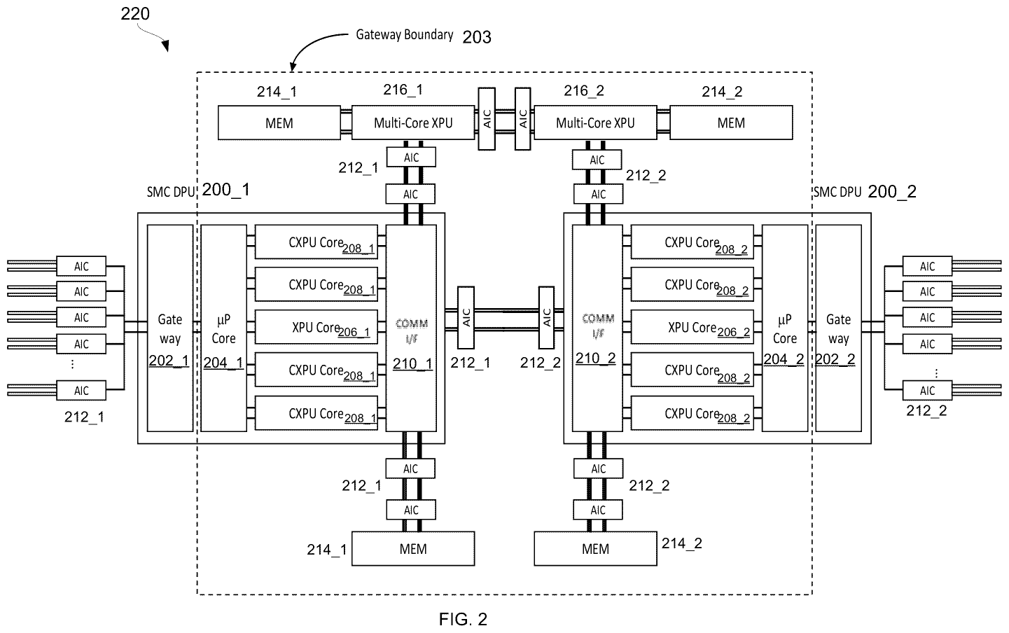

FIG. 2 depicts an example of a secure AI cloud cluster 220 comprising a plurality of SMC DPUs 200s connected with each other as well as with one or more external memories 214s and multi-core data processing units (e.g., MC XPUs) 216s via high-speed interconnects 212s. In some embodiments, each of the one or more external memories 214s can be but is not limited to a High Bandwidth Memory (HBM). In some embodiments, each of the one or more MC XPUs 216s includes one or more of the general purpose XPU cores and/or CXPU cores discussed above. Here, the secure AI cloud cluster 220 integrates the plurality of SMC DPUs 200s into a hardware configuration. Each of the plurality of SMC DPUs 200s and its components function in a similar manner as the SMC DPU 100 and its components discussed above.

In the example of FIG. 2, “inside the gateway” of the secure AI cloud cluster 220 means a gateway boundary 203 defined by the gateways 202s of the SMC DPUs 200s, wherein data within the gateway boundary 203 is protected and cannot be accessed directly by components or devices outside of the secure AI cloud cluster 220. The data inside the gateway boundary has to be first encrypted by and transmitted through the gateways 202s before such data can be accessed by the components or devices outside of the secure AI cloud cluster 220. Data received and decrypted by the gateways 202s is also processed only inside the gateway. As shown in the example of FIG. 2, the gateways 202s of the secure AI cloud cluster 220 are configured to communicate with components outside of the gateway boundary 203 using high-speed interconnects 212s, while components within the gateway boundary 203 are configured to communicate with each other via the high-speed interconnects 212.

In some embodiments, the secure AI cloud cluster 220 includes a plurality of domains wherein each of plurality of domains is regarded as “inside the gateway” if either it is entirely inside the gateway or has at least a portion of hardware inside the gateway. In some embodiments, the SMC DPUs 200s within the secure AI cloud cluster 220 may connect to other memories 214s and XPUs (e.g., MC XPUs) 216s as depicted by the example of FIG. 2. In this case, the domains of the SMC DPUs 200s, the memories 214s and the MC XPUs 216s are all within the gateway boundary 203, and are thus “inside the gateway” of the secure AI cloud cluster 220. In some embodiments, every domain inside the gateway of the secure AI cloud cluster 220 connects and communicates only to other domains inside the gateway.

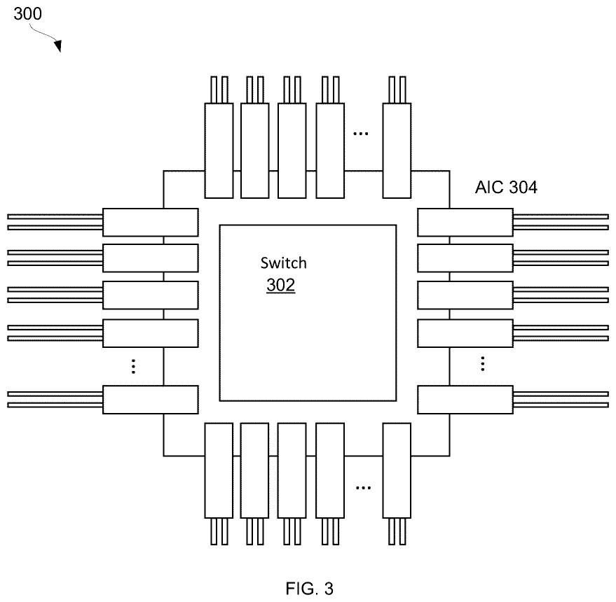

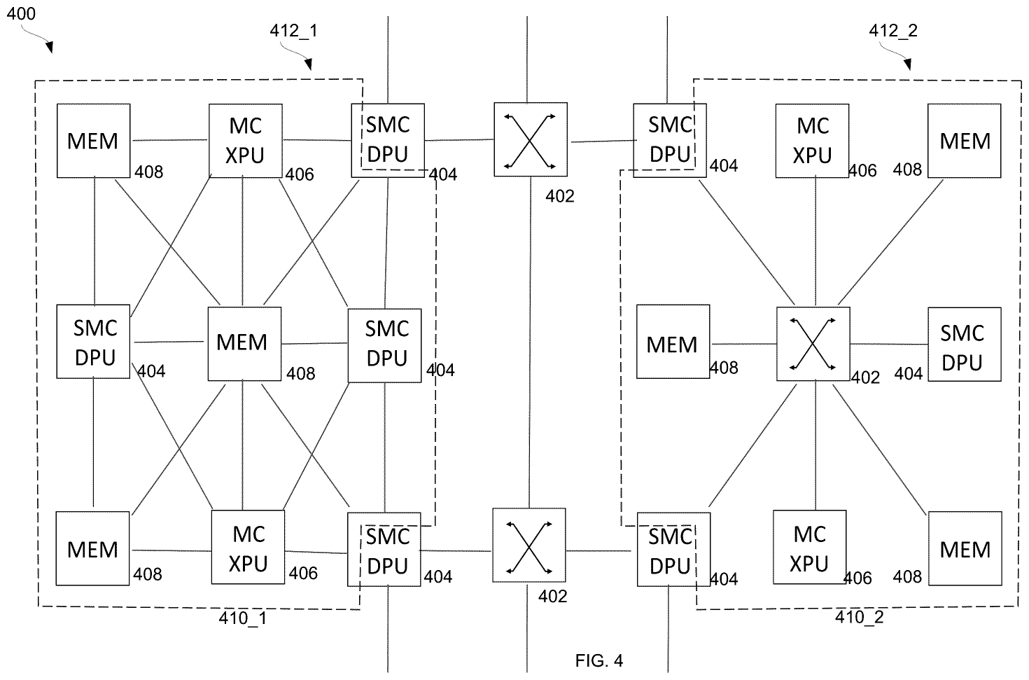

FIG. 3 depicts an example of a switch 302 used in a cloud network 300 and coupled via a plurality of high-speed interconnects (e.g., AICs) 304. In some embodiments, the high-speed interconnects 304 comprise CPOs as discussed above. The switch 302 may further connect/couple to one or more other switches 302s and/or the secure AI cloud clusters 220 as depicted in FIG. 4 below. The switch 302 is configured to direct data traffic, e.g., incoming data, computation instructions, and outgoing processing results among the one or more other switches 302s and/or the secure AI cloud clusters 220.

FIG. 4 depicts an example of an interconnected switch-enabled AI cloud network 400 comprising a plurality of switches 402s, a plurality of SMC DPUs 404s, a plurality of MC XPUs 406s, and a plurality of memories 408s, each functioning as discussed above. In some embodiments, the switch-enabled AI cloud network 400 includes one or more secure AI cloud clusters 410s, each comprising one or more of the switches 402s, the SMC DPUs 404s, the MC XPUs 406s, and memories 408s as discussed above. Each of one or more secure AI cloud clusters 408s has its own gateway boundary 412 and data communicated across the gateway boundaries 412s of the one or more AI cloud clusters 410s is encrypted. Note that in some embodiments, certain components of the switch-enabled AI cloud network 400, e.g., some of the switches 402s and/or SMC DPUs 404s, may be outside of the gateway boundaries 412s of the one or more secure AI cloud clusters 410s and are thus non-secure. The data communicated between the non-secure components and the secure components inside the gateway boundaries 410s is also encrypted. The switches 402s, the SMC DPUs 404s, the MC XPUs 406s, and the memories 408s in each AI cloud cluster can communicated with each other or components in another AI cloud cluster via either direct connections or through switches 402s which coordinate traffic across the gateway boundaries 412s. In some embodiments, the switches 402s, the SMC DPUs 404s, the MC XPUs 406s, and the memories 408s are connected via high-speed interconnects (not shown) and/or other interconnects, wherein the high-speed interconnects and/or other interconnects are proximate to or embedded within each of the switches 402s, the SMC DPUs 404s, the MC XPUs 406s, and the memories 408s. In some embodiments, the high-speed interconnects can be implemented using CPO as discussed above. All the components within the interconnected cloud network 400 may be connected either locally via CXL (or another protocol) or over a distance via Ethernet.

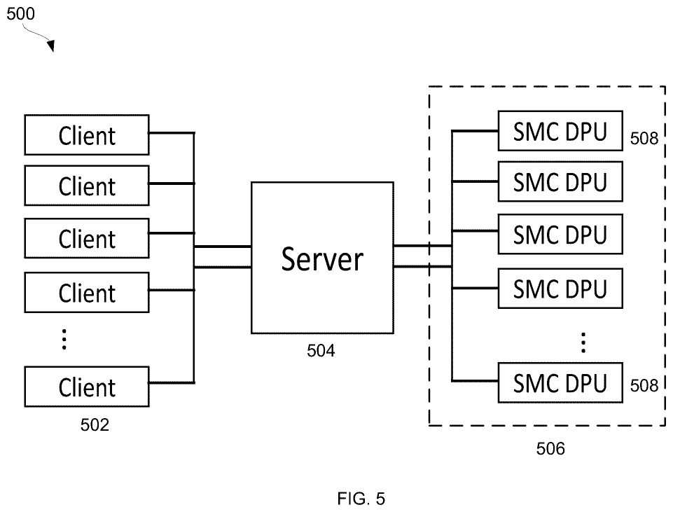

FIG. 5 depicts an example of a network architecture 500 for providing secure AI services to clients. In the example of FIG. 5, each of a plurality of clients 502s may forward/transmit one or more requests for computation (e.g., AI services) to a cloud server 504, wherein the one or more requests are encoded with, e.g., dual-key encryption, by the client. The cloud server 504 receives and transmits the one or more requests for computation to a SMC DPU-enabled network 506 (e.g., the switch-enabled AI cloud network 400 depicted in FIG. 4) for processing. In some embodiments, the SMC DPU-enabled network 506 comprises a plurality of SMC DPUs 508 as well as other components, e.g., switches and/or memories (not shown) as discussed above. In some embodiments, the plurality of SMC DPUs 508 in the SMC DPU-enabled network 506 can be integrated as one or more secure AI cloud clusters as discussed below. After the data has been processed by the SMC DPU-enabled network 506, the processing outcome/result is encrypted and returned to the requesting client 502 via the cloud server 504.

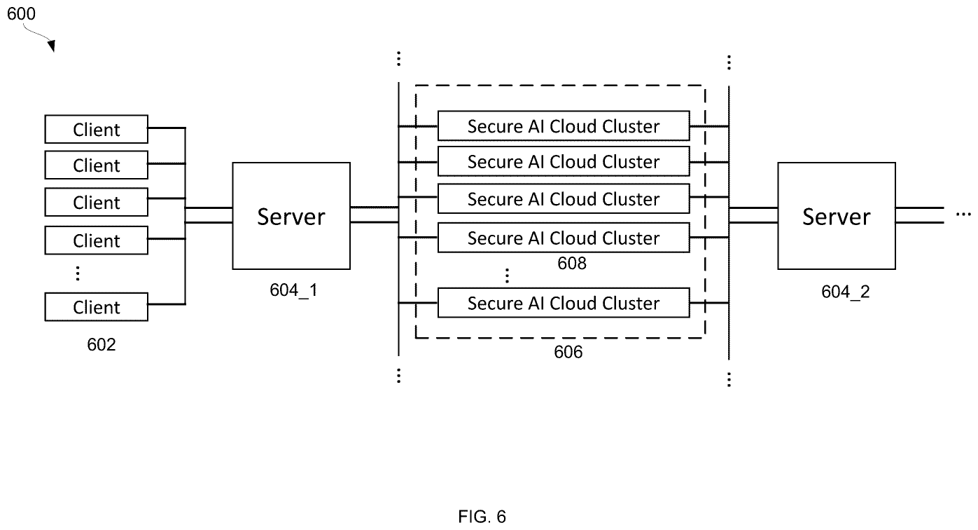

FIG. 6 depicts another example of a network architecture 600 for providing secure AI services to clients. In the example of FIG. 6, each of a plurality of clients 602s may forward/transmit one or more requests for computation (e.g., AI services) to a cloud server 604, wherein the one or more requests are encoded with, e.g., dual-key encryption, by the client. The cloud server 604_1 receives and transmits the one or more requests for computation to one of a plurality of secure AI cloud clusters 608s (e.g., one of the secure AI clusters depicted in FIG. 2-4) for processing. In some embodiments, the plurality of secure AI cloud clusters 608s are part of a SMC DPU-enabled network 606 discussed above. In some embodiments, each of the secure AI cloud clusters 608 comprises a plurality of SMC DPUs as well as other components, e.g., switches and/or memories as discussed above. After the data has been processed by the secure AI cloud cluster 606, the processing outcome/result is encrypted and returned to the requesting client 602 via the cloud server 604_1. In some embodiments, each secure AI cloud cluster 608 can be accessed at multiple access points, e.g., via multiple cloud servers 604_1 and 604_2 as shown in FIG. 6. The multiple access points allow the clients 602s to access one of the plurality of secure AI cloud clusters 606s via an alternate communication path through cloud server 604_2 if the communication network to one of the access points, e.g., cloud server 604_1 is down.

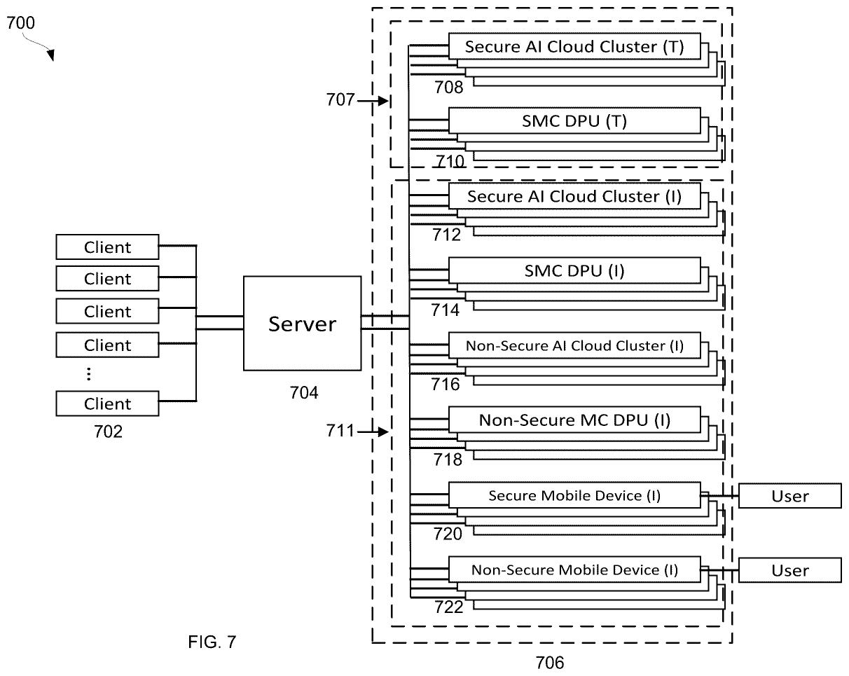

FIG. 7 depicts yet another example of a network architecture 700 for providing secure AI services to clients. In the example of FIG. 7, each of a plurality of clients 702s may forward/transmit one or more requests for computation (e.g., training and inference of one or more AI models) to a cloud server 704, wherein the one or more requests are encoded with, e.g., dual-key encryption, by the client. Here, each of the one or more AI models include software components and/or data that apply one or more algorithms to process data to, e.g., recognize patterns, make predictions, or make decisions, etc. The cloud server 704 receives and transmits the one or more requests for computation to a SMC DPU-enabled network 706 for processing. As shown by the example of FIG. 7, in some embodiments, the SMC DPU-enabled network 706 includes a training subsystem 707 having one or more secure AI cloud clusters (T) 708s and/or SMC DPUs (T) 710s discussed above, wherein the training subsystem 707 is configured to train the one or more AI models using private data maintained within a gateway boundary. After the one or more AI models have been trained by the one or more secure AI cloud clusters (T) 708s and/or SMC DPUs (T) 710s of the training subsystem 707, the one or more trained AI models (including, e.g., computation instructions and/or data representing the one or more trained AI models) are returned to the cloud server 704 and/or the clients 702s.

In some embodiments, the SMC DPU-enabled network 706 further includes one or more inference subsystems 711, wherein one of the inference subsystems 711 includes one or more secure AI cloud clusters (I) 712s and/or SMC DPUs (I) 714s configured to apply/utilize the one or more trained AI models to perform one or more inference operations on private data maintained within a gateway boundary as discussed above. Note that the gateways of the first subsystem and the second subsystems may be identical, overlapping, or different. In some embodiments, each of the one or more inference subsystems 711 is configured to provide/transmit outcome from the one or more inference operations back to the client. In some embodiments, each of the one or more inference subsystems 711 is configured to provide the outcome from the one or more inference operations to another party which can be but is not limited to a mobile device as discussed below, another client, a separate network, or a termination point in the field.

In some embodiments, one of the inference subsystems 711 includes one or more non-secure AI cloud clusters (I) 716s and/or non-secure multi-core DPUs (I) 718s configured to utilize the one or more trained AI models to perform inference operations on data maintained outside of the gateway boundary of the inference subsystem 711 and thus non-secure. In some embodiments, one of the inference subsystems 711 includes one or more secure mobile devices 720 and/or non-secure mobile devices 722 that are configured to perform the inference operations on data maintained inside and/or outside of the gateway boundary, respectively. These mobile devices are configured to communicate data and/or inference result to their associated clients visually, audibly, digitally, textually, or via other sensing means. In some embodiments, these mobile devices can also be used to retransmit, download, and/or transfer data to a system on the same, different, or an air-gapped network (e.g., military security).

In some embodiments, one of the inference subsystems 711 may include both secure and non-secure devices for inference operations. In some embodiments, one of the inference subsystems 711 may include only secure devices. In some embodiments, one of the inference subsystems 711 may include only non-secure devices. In some embodiments, one of the inference subsystems 711 may include only mobile devices.

In some embodiments, processing units and other components of the training subsystem 707 and/or the one or more inference subsystems 711 of the SMC DPU-enabled network 706 may be located at distributed locations and communicate with each other over one or more communication networks via wired (e.g., passive copper, active copper, or optics, etc.) or wireless (Wi-Fi, Bluetooth, 5G, proprietary etc.) means. As such, the network architecture 700 enables data privacy for AI model training by the training subsystem 707 using private or proprietary data of the clients while applying the trained one or more AI models on data that is either public or owned by another client via one of the inference subsystems 711s. Separating the SMC DPU-enabled network 706 between one or more training subsystems and inference subsystems also results in saving in computing resources since each inference subsystem 711 generally require less compute time and therefore may require less hardware than the training subsystem 707.

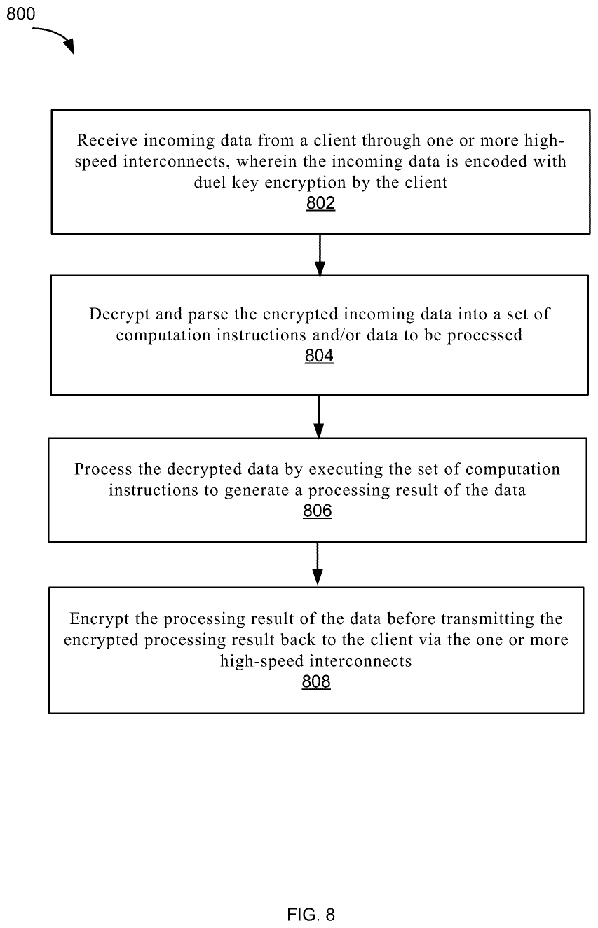

FIG. 8 depicts a flowchart 800 of an example of a process to support secure AI computing. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways.

In the example of FIG. 6, the flowchart 800 starts at block 802, where incoming data from a client is received through one or more high-speed interconnects, wherein the incoming data is encoded with, e.g., dual-key encryption, by the client. The flowchart 800 continues to step 804, where the encrypted incoming data is decrypted and parsed into a set of computation instructions and/or data to be processed. The flowchart 800 continues to step 806, where the decrypted data is processed by executing the set of computation instructions to generate a processing result of the data. The flowchart 800 ends at step 808, where the processing result of the data is encrypted before transmitting the encrypted processing result via the one or more high-speed interconnects.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A system, comprising:
a first subsystem having one or more secure processing units, wherein the first subsystem is configured to:
receive and decrypt an encrypted incoming request from a client for training one or more artificial intelligence (AI) models;
train the one or more AI models using data maintained within a first boundary of the first subsystem, wherein the data maintained within the first boundary is first encrypted before such data is accessed by components or devices outside of the first boundary; and
one or more second subsystems each having one or more processing units, wherein each of the one or more second subsystems is configured to
apply the one or more trained AI models to perform one or more inference operations; and
provide outcome of the one or more inference operations back to the client or to another party.

2. The system of claim 1, further comprising:
one or more cloud servers each configured to
receive and transmit the encrypted incoming request to the first subsystem, wherein the incoming request is encrypted by the client; and
receive and transmit the outcome of the one or more inference operations from the one or more second subsystems to the client.

3. The system of claim 1, wherein:
The processing units of the first subsystem and/or the one or more second subsystems are located at distributed locations and communicate with each other over one or more communication networks via wired or wireless means.

4. The system of claim 1, wherein:
each of the one or more processing units in each of the first subsystem and/or the one or more of the second subsystems is an architecture suited for organizing and/or processing certain type of data or an architecture suited for a neural network for network processing.

5. The system of claim 1, wherein:
each of the one or more processing units in each of the first subsystem and/or the one or more of the second subsystems is one of an open source core, a licensed core, and a core selected from a proprietary catalog provided by the client or a customer community.

6. The system of claim 1, wherein:
at least one of the one or more processing units in each of the first subsystem and/or the one or more of the second subsystems is a general purpose processing unit which configuration is updated as requirements evolve.

7. The system of claim 1, wherein:
at least one of the one or more processing units in each of the first subsystem and/or the one or more of the second subsystems is a customized processing unit hard-coded with a specific processing algorithm tailored for one or more specific applications.

8. The system of claim 7, wherein:
the customized processing unit is accessed and configured via one or more application programming interfaces (APIs) with encrypted third party intellectual property (IP) for the one or more specific applications.

9. The system of claim 1, wherein:
each of the one or more secure processing units in the first subsystem includes one or more secure multi-core data processing units (SMC DPUs), wherein each SMC DPU comprises:
a gateway configured to
decrypt and parse the encrypted incoming request into a set of computation instructions and/or data to be processed;
encrypt the outcome before providing the encrypted outcome;
one or more processing cores configured to process the decrypted data by executing the set of computation instructions to generate the outcome; and
a microprocessor core configured to manage data transfer between the gateway and the one or more processing cores.

10. The system of claim 9, wherein:
the gateways of the plurality of the one or more SMC DPUs are configured to define the first boundary of the first subsystem.

11. The system of claim 9, further comprising one or more of:
one or more memories configured to store the data and/or the outcome;
one or more switches each configured to connect and direct traffic among the one or more SMC DPUs; and
one or more high-speed interconnects connecting the SMC DPUs, the switches and the memories.

12. The system of claim 9, wherein:
one of the one or more second subsystems includes one or more SMC DPUs that defines a second boundary for the one or more inference operations, wherein the data maintained within the second boundary is first encrypted before such data is accessed by components or devices outside of the second boundary.

13. The system of claim 12, wherein:
one of the one or more second subsystems includes one or more non-secure multi-core DPUs configured to utilize the one or more trained AI models to perform the one or more inference operations on data maintained outside of the second boundary.

14. The system of claim 12, wherein:
one of the one or more second subsystems includes one or more mobile devices configured to
perform the one or more inference operations on data maintained either inside or outside of the second boundary; and
communicate with their associated clients visually, audibly, digitally, textually, or via other sensing means.

15. A method, comprising:
receiving and decrypting an encrypted incoming request from a client for training one or more artificial intelligence (AI) models;
training the one or more AI models using data maintained within a first boundary, wherein the data maintained within the first boundary is first encrypted before such data is accessed by components or devices outside of the first boundary;
applying the one or more trained AI models to perform one or more inference operations; and
providing outcome of the one or more inference operations back to the client or to another party.

16. The method of claim 15, further comprising:
encrypting the incoming request by the client.

17. The method of claim 15, further comprising:
decrypting and parsing the encrypted incoming request into a set of computation instructions and/or data to be processed;
processing the decrypted data by executing the set of computation instructions to generate the outcome; and
encrypting the outcome before providing the encrypted outcome.

18. The method of claim 15, further comprising:
defining a second boundary for the one or more inference operations, wherein the data maintained within the second boundary is first encrypted before such data is accessed by components or devices outside of the second boundary.

19. The method of claim 18, further comprising:
utilizing the one or more trained AI models to perform the one or more inference operations on data maintained outside of the second boundary.

20. The method of claim 18, further comprising:
performing the one or more inference operations on data maintained either inside or outside of the second boundary via one or more mobile devices; and
communicating with clients associated with the one or more mobile devices visually, audibly, digitally, textually, or via other sensing means.

21. A system, comprising:
a means for receiving and decrypting an encrypted incoming request from a client for training one or more artificial intelligence (AI) models;
a means for training the one or more AI models using data maintained within a first boundary, wherein the data maintained within the first boundary is first encrypted before such data is accessed by components or devices outside of the first boundary;
a means for applying the one or more trained AI models to perform one or more inference operations; and
a means for providing outcome of the one or more inference operations back to the client or to another party.
